(19) United States
(12) Patent Application Publication
(10) Pub. No.: US 2025/0096333 A1
(43) Pub. Date: Mar. 20, 2025

(54) METHOD FOR REGENERATING CAPACITY OF USED BATTERY AND DEVICE FOR IMPLEMENTING SAME

(71) Applicant: Korea Institute of Energy Technology, Naju-si (KR)

(72) Inventor: Juhyun SONG, Naju-si (KR)

(21) Appl. No.: 18/887,324

(22) Filed: Sep. 17, 2024

(30) Foreign Application Priority Data
Sep. 19, 2023 (KR) 10-2023-0124725

(51) Int. Cl. H01M 10/42

(52) U.S. Cl. CPC H01M 10/4242

(57) ABSTRACT

An embodiment relates to a method for regenerating the capacity of a used battery by connecting one or both terminals of a used battery and a lithium-supplying electrode to an external power supply unit to supply a lithium inventory to the used battery in order to restore a storage capacity of the used battery, and a device for regenerating the capacity of a used battery for implementing the method.

### CROSS-REFERENCE TO RELATED APPLICATIONS

This application claims the priority of Korean Patent Application No. 10-2023-0124725 filed on Sep. 19, 2023, in the Korean Intellectual Property Office, the disclosure of which is incorporated herein by reference.

### BACKGROUND

The performance of a battery, such as storage capacity, gradually degrades upon repeated charging, discharging, and resting, and this is referred to as aging of the battery. Chemical mechanisms of battery aging can be phenomenologically categorized into the following four aging modes: (1) loss of positive electrode active material, (2) loss of negative electrode active material, (3) loss of lithium inventory, and (4) increase in resistance. Mostly, multiple aging modes occur simultaneously. Although the contribution of each aging mode varies depending on the use environment and battery hardware, the loss of lithium inventory is known as one of the main aging modes in many cases.

The volume of aged batteries, secondhand from electric vehicles, is expected to increase sharply, as electric vehicles have rapidly penetrated the market last decade. With the environmental concern of disposing used batteries, and the supply chain instability of raw materials for ever-increasing battery demand, reutilizing the used batteries has gained attention. Used batteries are commonly either “reused” or “recycled” depending on their extent of degradation. First, “reuse” is a method of reutilizing used batteries with minimal structural change of original battery cells and packs, primarily in applications requiring lower performance than the first use. Though less costly, reused batteries have a lower residual value as their performance remains the same with the aged state in firsthand. Second, “recycle” is a method of recovering high-value materials from used batteries (e.g., cobalt and lithium), disassembling the original structure of battery cells and packs.

Though batteries of the recovered materials have relatively high performance, “recycle” may include chemically and thermally aggressive processes, which leads to a high production cost. Due to these disadvantages, research is still ongoing to find ways to reutilized used batteries that not only create significant residual value at low cost.

This work was supported by the National Research Foundation of Korea (NRF) grant funded by the Korea government (Ministry of Science and ICT) (No. 1711198380), and the KENTECH Research Grant (No. 202200046A).

### SUMMARY

A technical problem to be solved in the disclosure is to solve the above-described problems of the related art, and to provide a method for regenerating the capacity of a used battery.

Another technical problem to be solved in the disclosure is to provide a device for supplying a lithium inventory of a used battery.

The technical problems to be solved in the disclosure are not limited to the above-mentioned technical problems, and still other technical problems not mentioned will be clearly understood by those skilled in the art from the description below.

In order to solve the above technical problem, an embodiment of the disclosure provides method for regenerating the capacity of a used battery.

In an embodiment of the disclosure, a method for regenerating the capacity of a used battery may include: partially opening the container of a used battery; placing the open part and a lithium-supplying electrode into an electrolyte solution to create a lithium pathway; and connecting a terminal of opened used battery and a lithium-supplying electrode to an external power supply unit to supply lithium inventory to the opened used battery, to regenerate the capacity of the opened used battery.

Further, in an embodiment of the disclosure, the used battery may be a lithium secondary battery.

In addition, in an embodiment of the disclosure, the lithium-supplying electrode may include at least one selected from the group consisting of lithium metal and lithium-containing composites.

In addition, in an embodiment of the disclosure, the external power supply unit may control the potential difference and the current between a terminal of the opened used battery (either positive or negative) and the lithium-supplying electrode.

In addition, in an embodiment of the disclosure, by controlling the potential difference and the current, lithium ions may transport from the lithium-supplying electrode through the electrolyte solution to the electrode active material of the connected terminal (either positive or negative) of the opened used battery.

In addition, in an embodiment of the disclosure, the electrolyte solution may include a solvent obtained by dissolving salts that decompose into lithium ions and anions in a liquid organic solvent.

In order to solve the above technical problem, an embodiment of the disclosure provides another method for regenerating the capacity of a used battery.

In an embodiment of the disclosure, a method for regenerating the capacity of a used battery may include: connecting the used battery and a lithium-supplying cell to each other via a tube filled with an electrolyte solution therein; and connecting a terminal of the used battery and the lithium-supplying cell to an external power supply unit to supply lithium inventory to the used battery, to regenerate the capacity of the used battery.

In addition, in an embodiment of the disclosure, the lithium-supplying cell consists of a lithium-supplying electrode and electrolyte in a container with a terminal connected to the lithium-supplying electrode, In addition, in an embodiment of the disclosure, the external power supply unit may control the potential difference and the current between a terminal of the used battery (either positive or negative) and the lithium-supplying cell.

In order to solve the above technical problem, an embodiment of the disclosure provides a device for regenerating the capacity of a used battery.

In an embodiment of the disclosure, a device for regenerating the capacity of a used battery may include: a container filled with an electrolyte solution into which the used battery to be regenerated is placed; a lithium-supplying electrode introduced into the electrolyte solution; and an external power supply unit that applies voltage or current between the connected terminal of the used battery and the lithium-supplying electrode.

In addition, in an embodiment of the disclosure, the external power supply unit may be connected to the lithium-supplying electrode and one or both terminals of the used battery.

In addition, in an embodiment of the disclosure, the used battery and the lithium-supplying electrode may be spaced apart from each other and be in contact with the electrolyte solution.

In order to solve the above technical problem, an embodiment of the disclosure provides another device for regenerating the capacity of a used battery.

In an embodiment of the disclosure, a device for regenerating the capacity of a used battery may include: a tube filled with an electrolyte solution therein, which is connected to the used battery to be regenerated; a lithium-supplying cell connected to the other end of the tube; and an external power supply unit that applied voltage or current between the connected terminal of the used battery and the lithium-supplying cell.

In addition, in an embodiment of the disclosure, the tube filled with the electrolyte solution therein as ion channel may supply the lithium inventory from the lithium-supplying cell to the used battery.

The method for regenerating a used battery according to an embodiment of the disclosure provides the effect of regenerating the capacity of used battery by supplying lithium inventory and appropriately resetting the operating stoichiometry ranges of its cathode and anode active materials.

The method for regenerating the capacity of a used battery according to an embodiment of the disclosure provides the effect of preventing acceleration of aging by appropriately resetting the operating stoichiometry ranges of its cathode and anode active materials.

It is to be understood that the effects of the disclosure are not limited to the above-described effects, but include all effects that can be inferred from the configuration described in the detailed description or claims of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a flowchart showing a method for regenerating the capacity of a used battery according to an embodiment of the disclosure.

FIG. 2 is a schematic diagram showing a connection of a used battery to be regenerated to a device for regenerating the capacity of a used battery according to an embodiment of the disclosure.

FIG. 3 is a flowchart showing steps of another method for regenerating the capacity of a used battery according to an embodiment of the disclosure.

FIG. 4 is a schematic diagram showing connecting a used battery to be regenerated to another device for regenerating the capacity of a used battery according to an embodiment of the disclosure.

FIG. 5 is a schematic diagram showing a continuous process in which a device for regenerating the capacity of a used battery according to an embodiment of the disclosure is further coupled with a used battery moving unit, and a plurality of used batteries are moved while being regenerated.

### DETAILED DESCRIPTION

Hereinafter, the disclosure will be described with reference to the accompanying drawings. However, the disclosure may be embodied in a variety of different forms, and thus is not limited to the embodiments described herein. In addition, in the drawings, parts unrelated to the description are omitted in order to clearly explain the disclosure, and similar parts are assigned similar drawing reference numerals throughout the specification.

Throughout the specification, when a part is said to be “connected (joined, contacted, bonded)” with another part, it encompasses not only cases where it is “directly connected”, but also cases where it is “indirectly connected” with another member interposed therebetween. Also, when a part is said to “include” a component, it means that other components may be further provided, rather than excluding other components, unless otherwise specified.

The terminology used herein is for the purpose of describing particular embodiments only and is not intended to be limiting of the disclosure. The singular forms “a,” “an,” and “the” include plural referents unless the context clearly dictates otherwise. In this specification, terms such as “include” or “have” should be understood as specifying the presence of features, numbers, steps, operations, components, parts, or combinations thereof described in the specification, not excluding in advance the possibility of the presence or addition of one or more other features or numbers, steps, operation, components, parts or combinations thereof.

Hereinafter, embodiments of the disclosure will be described in detail with reference to the accompanying drawings.

Conventionally, there have been two main methods for recycling used batteries: reusing them with minimal structural change in products with lower performance requirement and recycling them by disassembling their original structure and recovering the high-value materials. However, the reuse method has a disadvantage of utilizing used batteries with degraded performance as is, resulting in low residual value. The recycling method, which involves chemical and thermal processes, has a disadvantage of high process costs and low recovery rates. Accordingly, the disclosure provides a method for regenerating the capacity of a used battery that solves the above-described problems.

Hereinafter, the disclosure will be described with reference to the figures presented in this specification. For reference, the figures may be exaggerated to some extent in order to illustrate features of the disclosure. In such cases, it is preferable to interpret them in light of the overall gist of the present specification.

A method for regenerating the capacity of a used battery according to an embodiment of the disclosure will be described.

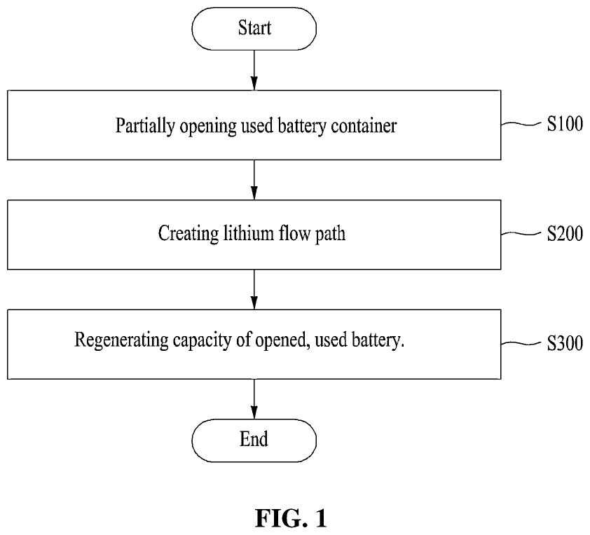

FIG. 1 is a flowchart showing a method for regenerating the capacity of a used battery according to an embodiment of the disclosure.

Referring to FIG. 1, a method for regenerating the capacity of a used battery according to an embodiment of the disclosure may include: partially opening an used battery container S100; placing the opened part and a lithium-supplying electrode into an electrolyte solution to create a lithium pathway S200; and connecting a terminal of the opened used battery and the lithium-supplying electrode to an external power supply unit to supply lithium inventory to the opened used battery, to regenerate the capacity of the opened used battery S300.

The first step may include partially opening a used battery container S100.

At this time, the reason for partially opening the used battery container is to expose the electrodes of the used battery by opening part of the battery container when the electrodes of the used battery 130 are located inside a specific type of battery container, thereby creating a lithium pathway.

Thus, there may be no additional need to open the container in case of using a used battery in which the electrodes have already been exposed.

The second step may include placing the opened used battery, which a used battery opened by partially opening the used battery container, and a lithium-supplying electrode into an electrolyte solution to create a lithium pathway S200.

In this case, the used battery may be a lithium secondary battery.

In addition, the used battery may be a battery with reduced lithium inventory.

At this time, the lithium inventory indicates the amount of lithium that flows between the positive electrode and the negative electrode when the battery is charged and discharged. As the battery is used, the lithium inventory is reduced by side reactions (solid electrolyte interface (SEI) formation and lithium metal deposition reaction), which may cause battery aging and capacity reduction.

Thus, lithium inventory may be supplied to the used battery in order to regenerate the capacity of such used battery.

Meanwhile, the electrolyte solution may include a solvent obtained by dissolving salts that decompose into lithium ions and anions in a liquid organic solvent.

In this case, the liquid organic solvent may include liquid organic solvents such as EC or DMC, but is not limited to these, as long as the solvent may decompose and dissolve the salts into lithium ions and anions.

In addition, in the case of the electrolyte solution, since it serves to allow the transport of lithium ions from the lithium-supplying electrode to the opened used battery, a suitable electrolyte solution may be used to create a lithium pathway through which lithium ions from the lithium-supplying electrode may flow to the used battery.

Meanwhile, the lithium-supplying electrode may include at least one selected from the group consisting of lithium metal and lithium-containing composites.

In this case, the lithium-supplying electrode, which is used to supply lithium inventory to the used battery, may utilize lithium-containing composites.

The last step may include connecting a terminal of the opened used battery (either positive or negative) and the lithium-supplying electrode to an external power supply unit to supply lithium inventory to the opened used battery, to regenerate the capacity of the opened used battery S300.

The external power supply unit may control the voltage or the current between the connected terminal of the used battery and the lithium-supplying electrode.

In this case, the control of the voltage by the external power supply unit may be achieved by passing a current between the connected terminal of the used battery and the lithium-supplying electrode to adjust the lithium stoichiometry of the electrode active material of the connected terminal (either positive or negative).

At this time, when the potential of the terminal with respect to the lithium-supplying electrode is lower than the open-circuit voltage (OCV), lithium ions transport from the lithium-supplying electrode through the electrolyte solution to the electrode active material of the connected terminal (either positive of negative) of the used battery.

Specifically, when the potential of the terminal with respect to the lithium-supplying electrode is lower than the OCV, lithium ion may be released from the lithium-supplying electrode and move to the used battery based on the principles of diffusion and migration due to the thermodynamic driving force.

Another method for regenerating the capacity of a used battery according to an embodiment of the disclosure will be described.

Another method for regenerating the capacity of a used battery according to the disclosure may be applied to all the details described for the above-described method for regenerating the capacity of a used battery. Although detailed descriptions of overlapping parts are omitted, but the same manner may be applied even if the descriptions are omitted.

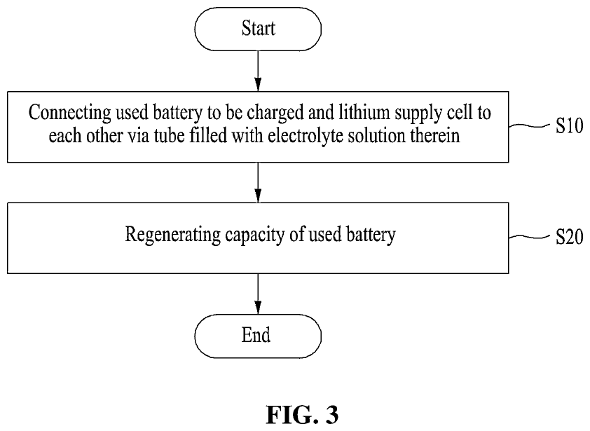

FIG. 3 is a flowchart showing steps of another method for regenerating the capacity of a used battery according to an embodiment of the disclosure.

Referring to FIG. 3, a method for regenerating the capacity of a used battery according to an embodiment of the disclosure may include: connecting the used battery to be regenerated and a lithium-supplying cell to each other via a tube filled with an electrolyte solution therein S10; and connecting a terminal of the used battery and the lithium-supplying cell to an external power supply unit to supply lithium inventory to the used battery, to regenerate the capacity of the used battery S20.

In the step of connecting the used battery and a lithium-supplying cell to each other via a tube filled with an electrolyte solution therein, the lithium pathway may be created in the lithium-supplying cell by inserting the tube filled with the electrolyte solution therein into the used battery without opening the container of the used battery.

Thus, in that method, the container of the used battery may not be partially opened.

In addition, the tube filled with the electrolyte solution therein may include, but is not limited to, a thin tube in the shape of a syringe needle.

In addition, the electrolyte solution may include a solvent obtained by dissolving salts that decompose and dissolve into lithium ions and anions in a liquid organic solvent, but is not limited to these, as long as the electrolyte solution allows transport of lithium ions.

Meanwhile, the external power supply unit may control the voltage or the current between the connected terminal of the used battery and the lithium-supplying cell.

This may facilitate the transport of lithium ions from the lithium-supplying cell to the used battery.

A device for regenerating the capacity of a used battery according to an embodiment of the disclosure will be described.

A device for regenerating the capacity of a used battery according to the disclosure may be applied to all the details described for the above-described method for regenerating the capacity of a used battery. Although detailed descriptions of overlapping parts are omitted, but the same manner may be applied even if the descriptions are omitted.

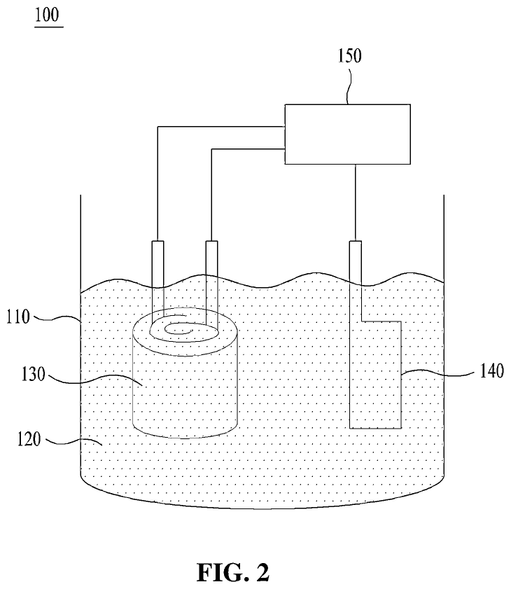

FIG. 2 is a schematic diagram showing a connection of a used battery to be regenerated to a device for regenerating the capacity of the used battery according to an embodiment of the disclosure.

Referring to FIG. 2, the device 100 for regenerating the capacity of a used battery may include: a container 110 filled with an electrolyte solution 120 into which the used battery 130 is placed; a lithium-supplying electrode 140 placed into the electrolyte solution 120; and an external power supply unit 150 that applies voltage or current between the connected terminal of the used battery and the lithium-supplying electrode.

The disclosure may include a container filled with an electrolyte solution into which the used battery to be regenerated is placed.

In this case, the used battery 130 may have various types of shapes such as a cylindrical shape, a square shape, a pouch shape, or a coin shape.

In addition, when the electrodes of the used battery 130 are located inside a specific type of battery pack, the electrodes of the used battery may be exposed by opening part of the battery pack container as well as cell container.

The disclosure may also include a lithium-supplying electrode.

In this case, the lithium-supplying electrode 140, which is used to supply lithium inventory to the used battery, may utilize a lithium metal electrode and lithium-containing composites.

The disclosure may also include an external power supply unit that applies a voltage or current.

In this case, the external power supply unit 150 may be located outside the container filled with the electrolyte solution into which the used battery to be charged is placed.

Meanwhile, the external power supply unit 150 may be connected to the lithium-supplying electrode 140 and one or both terminals of the used battery 130.

In this case, for the used battery 130 connected to the external power supply unit 150, a part of the used battery container is opened, so that the electrodes of the used battery are exposed, and the external power supply unit may be connected to the electrodes of the used battery. Meanwhile, the used battery 130 and the lithium-supplying electrode 140 may be spaced apart from each other and be in contact with the electrolyte solution 120.

In this case, when the used battery 130 and the lithium-supplying electrode 140 are not spaced apart from each other and are in contact with the electrolyte 120, there may be a problem where the external power supply unit 150 cannot adjust the potential difference, leading to an inability to supply lithium.

Meanwhile, the time point at which the lithium inventory supply to the used battery 130 is considered complete can be determined as the time point when the voltage or current falls below a certain threshold.

In this case, the certain threshold for voltage or current may be determined according to the amount of the current passed or the remaining voltage between the connected terminal of the used battery and the lithium-supplying electrode.

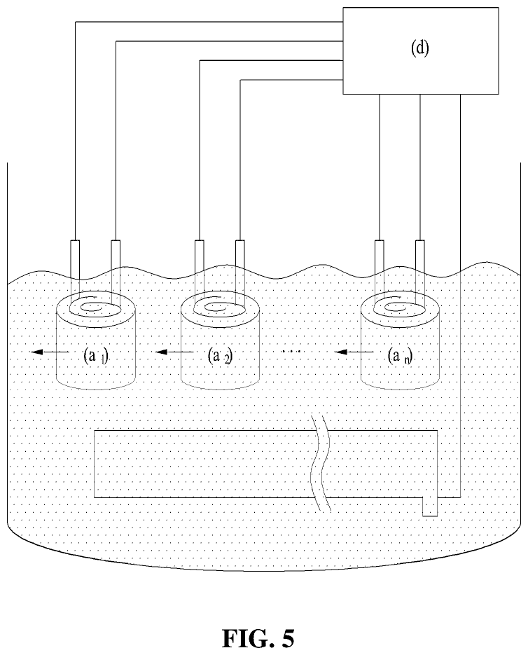

FIG. 5 is a schematic diagram showing a continuous process in which a device for regenerating the capacity of a used battery according to an embodiment of the disclosure is further coupled with a used battery moving unit, and a plurality of used batteries are moved while being regenerated.

Referring to FIG. 5, a device for regenerating the capacity of a used battery according to an embodiment of the disclosure may be connected to an external power supply device d for a plurality of used batteries a1, a2, and an to be charged, and a device for moving the batteries that have completed charging is additionally coupled to the device for regenerating the capacity of the used battery so that the capacity of the used battery may be regenerated in a continuous process.

Another device for regenerating the capacity of a used battery according to an embodiment of the disclosure will be described.

Another device for regenerating the capacity of a used battery according to the disclosure may be applied to all the details described for the above-described device for regenerating the capacity of a used battery. Although detailed descriptions of overlapping parts are omitted, but the same manner may be applied even if the descriptions are omitted.

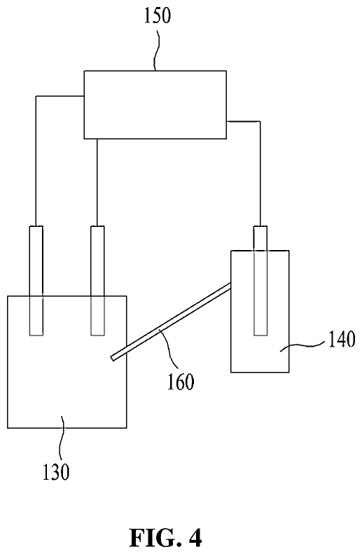

FIG. 4 is a schematic diagram showing connecting a used battery to be regenerated to another device for regenerating the capacity of the used battery according to an embodiment of the disclosure.

Referring to FIG. 4, a device for regenerating the capacity of a used battery according to an embodiment of the disclosure may include: a tube 160 filled with an electrolyte solution therein, which is connected to the used battery; a lithium-supplying cell connected to one end of the tube 160 filled with electrolyte solution therein; and an external power supply unit that applies voltage or current between a terminal of the used battery and the lithium-supplying cell.

In this case, the tube 160 filled with the electrolyte solution therein as ion channel may supply the lithium inventory from the lithium-supplying cell to the used battery to be regenerated.

Meanwhile, the tube includes a thin tube in the shape of a syringe needle, wherein by inserting and connecting the tube into the used battery, the lithium inventory may be supplied without partially opening the container of the used battery.

Specifically, the electrodes of the used battery and the lithium-supplying cell electrode are connected to each other through the tube, and at this time, the electrolyte filled inside the tube serves as a pathway of lithium ion.

Hereinafter, the disclosure will be described in more detail with reference to examples. These examples are intended to illustrate the disclosure only, and the scope of the disclosure is not limited by these examples.

### Example

The lithium stoichiometry range and lithium inventory of the positive electrode and the negative electrode in the new state of a battery were determined by open circuit voltage (OCV) and dV/dQ measurements in the initial state before aging of a battery (NMC-graphite, pouch-type lithium ion battery).

Subsequently, the battery was charged and discharged under certain conditions to cause accelerated aging (e.g., 1C CCCV charge and 1C discharge) and the aging of the battery was stopped when the remaining available capacity reached a certain level (e.g., 70%). Through the OCV and dV/dQ measurements of the aged battery, the lithium stoichiometry range and lithium inventory of the positive electrode and the negative electrode in the aged state were determined.

After discharging the battery to the minimum operating voltage (e.g., 3V), a portion of the pouch of the used battery was then opened and its positive terminal was connected to a device for regenerating the used battery, in a dry room or glove box that can minimize moisture exposure.

Finally, the capacity of the aged battery was regenerated by applying a current in a direction from the lithium-supplying electrode to the connected positive electrode of the used battery, until an enough amount of current has passed to supply lithium inventory to the used battery to recover the lithium stoichiometry of the positive electrode at the initial, discharged state.

It can be seen from the above embodiment that supplying lithium inventory to the used battery to regenerate the capacity of the used battery results in partial restoration of the capacity of the used battery in the following charging and discharging cycles.

As a result, it can be seen that the capacity of the used battery may be regenerated by supplying the lithium inventory utilizing the external power supply unit and the lithium-supplying electrode when the capacity reduction of the used battery is partially or entirely due to the reduction in lithium inventory.

The regeneration step may be performed at any state of charge, though described at the fully discharged state above, and the negative terminal may be connected instead of, or as well as, the positive terminal to the regenerating device, to supply lithium inventory to the anode of the used battery as well.

The foregoing description of the disclosure is intended to be illustrative, and it will be understood by those skilled in the art that other specific forms may be easily modified without changing the technical idea or essential features of the disclosure. It should therefore be understood that the embodiments described above are illustrative in all respects and not restrictive. For example, each component described as being unitary may be implemented in a distributed manner, and similarly, components described as being distributed may also be implemented in a combined manner.

The scope of the disclosure is indicated by the claims described below, and all changes or modifications derived from the meaning and scope of the claims and their equivalent concepts should be construed as being included in the scope of the disclosure.

### DESCRIPTION OF SIGNS

100: device for regenerating capacity of used battery
110: container
120: electrolyte solution
130: used battery
140: lithium-supplying electrode or lithium-supplying cell
150: external power supply unit
160: tube filled with an electrolyte solution therein

What is claimed is:

1. A method for regenerating a capacity of a used battery, comprising:
partially opening a used battery container;
placing the opened used battery and a lithium-supplying electrode into an electrolyte solution to create a lithium pathway; and
connecting one or both terminals of the opened used battery and the lithium-supplying electrode to an external power supply unit to supply lithium inventory to the opened used battery, to regenerate the capacity of the opened used battery.

2. The method for regenerating the capacity of a used battery of claim 1, wherein:
the used battery is a lithium secondary battery.

3. The method for regenerating the capacity of a used battery of claim 1, wherein:
the lithium-supplying electrode comprises at least one selected from a group consisting of lithium metal and lithium-containing composites.

4. The method for regenerating the capacity of a used battery of claim 1, wherein:
the external power supply unit is configured to control a voltage or current between the connected terminal of the opened used battery and the lithium-supplying electrode.

5. The method for regenerating the capacity of a used battery of claim 1, wherein:
when a potential difference between the opened used battery and the lithium-supplying electrode is lower than an equilibrium potential difference, lithium from the lithium-supplying electrode moves through the electrolyte solution to an electrode active material of the connected terminal of the opened used battery.

6. The method for regenerating the capacity of a used battery of claim 1, wherein:
the electrolyte solution comprises a solvent obtained by dissolving salts that decompose and dissolve into lithium ions and anions in a liquid organic solvent.

7. A method for regenerating a capacity of a used battery, comprising:
connecting the used battery to be regenerated and a lithium-supplying cell to each other via a tube filled with an electrolyte solution therein; and
connecting one or both terminals of the used battery and the lithium-supplying cell to an external power supply unit to supply lithium inventory to the used battery, to regenerate the capacity of the used battery.

8. The method for regenerating the capacity of a used battery of claim 7, wherein:
the external power supply unit is configured to control a voltage or current between the connected terminal of the used battery and the lithium-supplying cell.

9. A device for regenerating a capacity of a used battery, comprising:
a container filled with an electrolyte solution into which the used battery to be regenerated is placed;
a lithium-supplying electrode introduced into the electrolyte solution; and
an external power supply unit that applies voltage or current between a connected terminal of the used battery and the lithium-supplying electrode.

10. The device for regenerating the capacity of a used battery of claim 9, wherein:
the external power supply unit is connected to one or both terminals of the used battery and the lithium-supplying electrode.

11. The device for regenerating the capacity of a used battery of claim 9, wherein:
the used battery and the lithium-supplying electrode are spaced apart from each other and are in contact with the electrolyte solution.

12. A device for regenerating a capacity of a used battery, comprising:
a tube filled with an electrolyte solution therein, which is connected to the used battery to be regenerated;
a lithium-supplying cell connected to one end of the tube filled with electrolyte solution therein; and
an external power supply unit that applies voltage or current between a connected terminal of the used battery and the lithium-supplying cell.

13. The device of for regenerating the capacity of a used battery claim 12, wherein:
the tube filled with the electrolyte solution therein as ion channel supplies lithium inventory from the lithium-supplying cell to the used battery to be regenerated.
